(19) United States
(12) Patent Application Publication
(10) Pub. No.: US 2017/0002683 A1
(43) Pub. Date: Jan. 5, 2017

(54) STEAM TURBINE SHELL DEFLECTION FAULT-TOLERANT CONTROL SYSTEM, COMPUTER PROGRAM PRODUCT AND RELATED METHODS

(71) Applicant: General Electric Company, Schenectady, NY (US)

(72) Inventor: Mert Geveci, Delmar, NY (US)

(21) Appl. No.: 14/790,301

(22) Filed: Jul. 2, 2015

(51) Int. Cl. F01D 21/12; F01D 25/14; G05B 15/02; F01D 25/26

(52) U.S. Cl. CPC F01D 21/12; F01D 25/26; F01D 25/14; G05B 15/02; F05D 2220/31; F05D 2260/20; F05D 2270/303

(57) ABSTRACT

Various approaches include: obtaining temperature data indicating temperatures of distinct zones in an upper half of a steam turbine shell and a lower half of a steam turbine shell; determining whether a difference between a temperature of a zone in the upper half of the steam turbine shell and a temperature of a neighboring zone in the lower half of the steam turbine shell exceeds a threshold; and initiating a change in a state of a thermal element in at least one of an adjacent zone to at least one of the zone in the upper half of the steam turbine shell or the neighboring zone in the lower half of the steam turbine shell in response to determining the difference exceeds the threshold.

### FIELD OF THE INVENTION

The subject matter disclosed herein relates to turbomachines (e.g., turbines). More particularly, the subject matter disclosed herein relates to controlling thermal parameters of turbines, such as steam turbines.

### BACKGROUND OF THE INVENTION

Steam turbines translate the flow of fluid (steam) into rotational movement using a rotor with adjoining sets of blades. The rotor and blades are contained within a diaphragm, and outside the diaphragm, a shell (also referred to as a casing). Variations in the temperature of the steam flowing through the turbine can cause components in the system, to shift, deflect, or otherwise move. This movement can cause rubbing, and/or interference of components, which decreases the efficiency of the turbine. Mechanisms exist to counteract this movement, such as thermal elements, but controlling those mechanisms can be difficult. In particular, when faults in the control mechanisms occur, it can be difficult to adequately counteract component deflection in steam turbines.

### BRIEF DESCRIPTION OF THE INVENTION

Various embodiments of the disclosure include a system having: at least one computing device configured to control a state of a thermal element in contact with a steam turbine shell having an upper half and a lower half, by performing actions including: obtaining temperature data indicating temperatures of distinct zones in the upper half of the steam turbine shell and the lower half of the steam turbine shell, the thermal element having corresponding distinct zones as the upper half of the steam turbine shell and the lower half of the steam turbine shell; determining whether a difference between a temperature of a zone in the upper half of the steam turbine shell and a temperature of a neighboring zone in the lower half of the steam turbine shell exceeds a threshold; and initiating a change in the state of the thermal element in at least one of an adjacent zone to at least one of the zone in the upper half of the steam turbine shell or the neighboring zone in the lower half of the steam turbine shell in response to determining the difference exceeds the threshold.

A first aspect of the disclosure includes a system having: at least one computing device configured to control a state of a thermal element in contact with a steam turbine shell having an upper half and a lower half, by performing actions including: obtaining temperature data indicating temperatures of distinct zones in the upper half of the steam turbine shell and the lower half of the steam turbine shell, the thermal element having corresponding distinct zones as the upper half of the steam turbine shell and the lower half of the steam turbine shell; determining whether a difference between a temperature of a zone in the upper half of the steam turbine shell and a temperature of a neighboring zone in the lower half of the steam turbine shell exceeds a threshold; and initiating a change in the state of the thermal element in at least one of an adjacent zone to at least one of the zone in the upper half of the steam turbine shell or the neighboring zone in the lower half of the steam turbine shell in response to determining the difference exceeds the threshold.

A second aspect of the disclosure includes a computer program product having program code, which when executed by one computing device, causes the at least one computing device to control a state of the thermal element in contact with a steam turbine shell having an upper half and a lower half, by performing actions including: obtaining temperature data indicating temperatures of distinct zones in the upper half of the steam turbine shell and the lower half of the steam turbine shell, the thermal element having corresponding distinct zones as the upper half of the steam turbine shell and the lower half of the steam turbine shell; determining whether a difference between a temperature of a zone in the upper half of the steam turbine shell and a temperature of a neighboring zone in the lower half of the steam turbine shell exceeds a threshold; and initiating a change in the state in the thermal element in at least one of an adjacent zone to at least one of the zone in the upper half of the steam turbine shell or the neighboring zone in the lower half of the steam turbine shell in response to determining the difference exceeds the threshold.

A third aspect of the disclosure includes a system having: a thermal element for contacting a steam turbine shell having an upper half and a lower half; and a control system including at least one computing device configured to control a temperature of the thermal element by performing actions including: obtaining temperature data indicating temperatures of distinct zones in the upper half of the steam turbine shell and the lower half of the steam turbine shell, the thermal element having corresponding distinct zones as the upper half of the steam turbine shell and the lower half of the steam turbine shell; determining whether a difference between a temperature of a zone in the upper half of the steam turbine shell and a temperature of a neighboring zone in the lower half of the steam turbine shell exceeds a threshold; and initiating a change in a state of the thermal element in at least one of an adjacent zone to at least one of the zone in the upper half of the steam turbine shell or the neighboring zone in the lower half of the steam turbine shell in response to determining the difference exceeds the threshold.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIG. 1 shows a schematic depiction of a steam turbine casing and monitoring components according to various embodiments of the disclosure.

FIG. 2 shows a side cross-sectional view of a portion of casing from FIG. 1, contacted by a thermal element.

FIG. 3 shows a flow diagram illustrating a method performed according to particular embodiments of the disclosure.

FIG. 4 shows a schematic signal diagram illustrating example control processes according to various embodiments of the disclosure.

FIG. 5 shows an example graphical depiction of Tᵤₚₚₑᵣ Adjustment (in degrees Fahrenheit(F)) v. ΔT Error (in degrees F.) based upon the control diagram of FIG. 4.

FIG. 6 shows an example feedback gain matrix (K) from the control diagram of FIG. 4.

FIG. 7 shows an environment including a system for controlling deflection of the steam turbine shell of FIG. 1, according to various embodiments of the disclosure.

It is noted that the drawings of the invention are not necessarily to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

As indicated above, the subject matter disclosed herein relates to turbomachines (e.g., turbines). More particularly, the subject matter disclosed herein relates to controlling thermal parameters of turbines, such as steam turbines.

Peak-to-peak deflections of the steam turbine's shell during startup and shutdown play a role in selection of clearances within the turbine (e.g., metal-to-metal clearances). Recent approaches for minimizing peak-to-peak deflections in steam turbines employ thermal elements, e.g., nets (or “blankets”) to manage temperature distribution across the turbine shell. The blanket is located between the metal shell and its external insulation (radially outboard of the shell). However, over the designed lifetime of the steam turbine (e.g., decades), the thermal blanket can experience faults, which conventional approaches fail to adequately control.

In contrast to conventional approaches, various aspects of the disclosure include systems, computer program products and associated methods to control thermally-induced deflections in a steam turbine shell. In some particular cases, various embodiments described herein can account for the potential of thermal blanketing or netting (or other thermal elements) to fail, at least in part, and adequately control temperatures at the shell in order to compensate for that potential failure.

The shell deflection control system according to various embodiments has two primary control parameters: 1) accurately control of temperature differential between the upper section of the shell and the lower section of the shell. That is, shell deflections are commonly driven by the temperature differential across the upper/lower sections of the shell; and 2) maintain the temperature of both the upper and lower shell sections above a set of thresholds. Keeping the shell sections above threshold temperatures can help shorten the time required to start-up (warm-up) the turbine for designed operation. While the conventional thermal element control systems may be configured to maintain the above-noted operating parameters under nominal conditions (e.g., normal operating conditions), these conventional systems are inadequate to maintain these parameters during off-nominal conditions (e.g., when failure occurs in one or more sections of the thermal element). As such, the shell deflection control system according to various embodiments is configured to maintain the above-noted parameters during at least one of the following off-nominal conditions: a) loss of individual thermal element zones; b) loss of groups of thermal element zones (e.g., due to partial power supply loss, such as loss of transformer leg); c) improperly installed insulation, resulting in excessive heat losses from the shell to the environment; and/or d) improperly installed thermal element, resulting in undesired heat transfer characteristics to/from the shell.

In the following description, reference is made to the accompanying drawings that form a part thereof, and in which is shown by way of illustration specific example embodiments in which the present teachings may be practiced. These embodiments are described in sufficient detail to enable those skilled in the art to practice the present teachings and it is to be understood that other embodiments may be utilized and that changes may be made without departing from the scope of the present teachings.

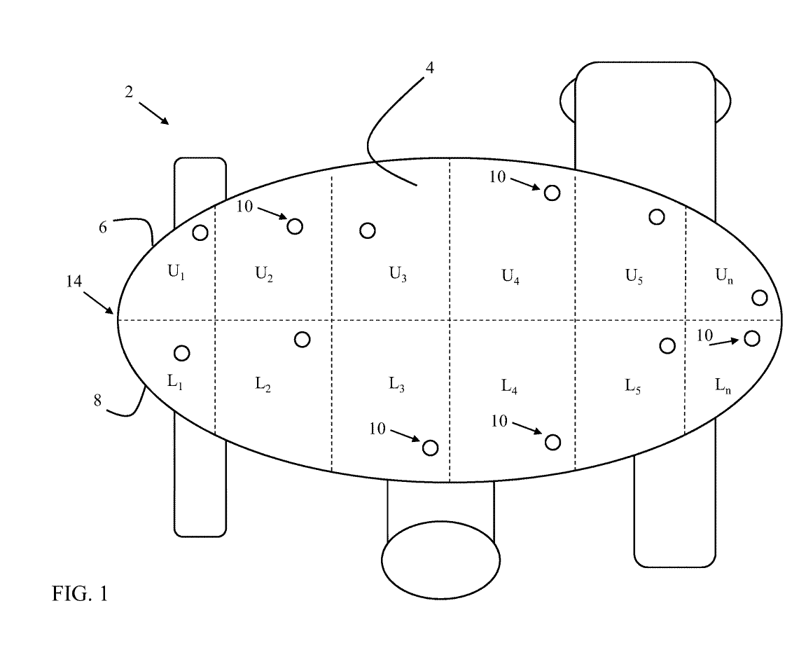

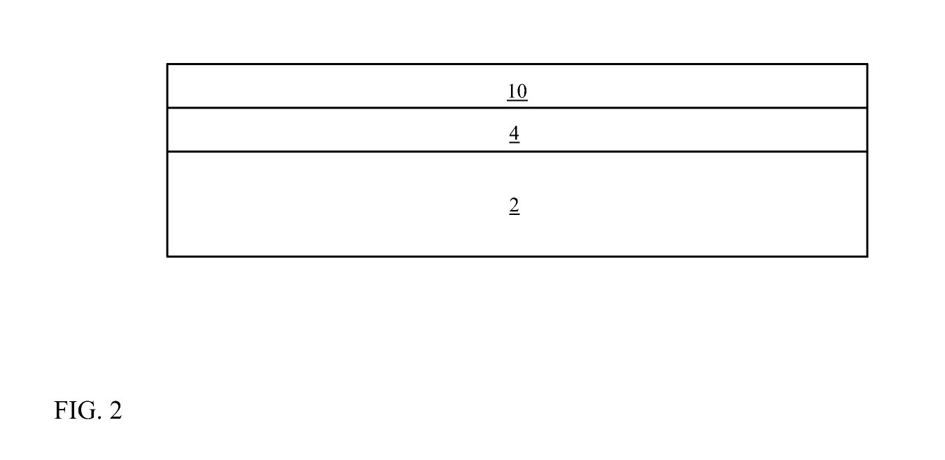

FIG. 1 shows a schematic depiction of a steam turbine casing 2 and monitoring components according to various embodiments of the disclosure. The casing 2 is wrapped in a thermal element 4 (e.g., a thermal blanket, thermal net, ceramic heater and/or inductive heater), which is shown as including a plurality of zones corresponding with an upper half 6 and lower half 8 of the casing 2, respectively. The thermal element 4 can include any conventional thermal (heat) element configured to act as a heat source, e.g., via flow of electrical current through wiring/resistors, flow of fluid (e.g., heated fluid such as water) through conduits, and/or chemical reaction. In any case, the thermal element 4 can be configured to provide heat in one or more localized regions (zones) as described herein, and can be controlled according to various embodiments of the disclosure. Zones in the element 4 (and correspondingly in the casing 2) are denoted as corresponding to the half of the casing 2 in which they reside e.g., U₁, U₂, U₃, etc. for upper half 6 and L₁, L₂, L₃, etc. for lower half 8. As shown, a plurality of temperature sensors (e.g., thermocouples) 10 (several labeled) can be located on the casing 2 to provide temperature measurements at the distinct zones (e.g., U₁, U₂, U₃, L₁, L₂, L₃, etc.) of the casing 2. FIG. 2 shows a side cross-sectional view of a portion of casing 2, contacted by thermal element 4, which is covered (at least in part) by insulation 12 (e.g., conventional insulation used in turbine industry).

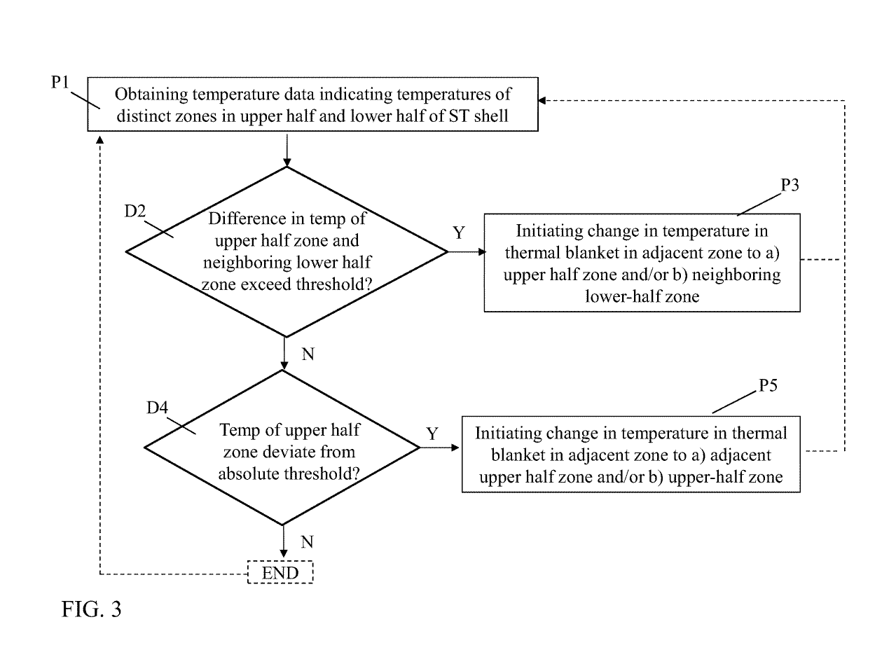

FIG. 3 shows a flow diagram illustrating a process of controlling a temperature of thermal element 4 in contact with steam turbine shell (casing) 2 according to various embodiments of the invention. These processes can be performed, e.g., by at least one computing device, as described herein. In other cases, these processes can be performed according to a computer-implemented method of controlling a temperature of thermal element 4 in contact with steam turbine shell 2. In still other embodiments, these processes can be performed by executing computer program code on at least one computing device, causing the at least one computing device to control a temperature of thermal element 4 in contact with steam turbine shell 2. In general, the process can include the following sub-processes:

Process P1: obtaining temperature data indicating temperatures of distinct zones (U₁, U₂, U₃, etc.) in the upper half 6 of steam turbine shell 2 and distinct zones (L₁, L₂, L₃, etc.) in the lower half 8 of steam turbine shell 2. In various embodiments, this can include obtaining temperature measurements from temperature sensors 10 located in each of the zones (upper and lower), on a periodic (e.g., recurring) basis. In various embodiments, this process can include periodically measuring temperatures at the zones using the temperature sensors 10. It is understood that thermal element 4 has corresponding distinct zones (e.g., U₁, U₂, U₃, L₁, L₂, L₃, etc.) as upper half 6 of steam turbine shell 2 and lower half 8 of steam turbine shell 2. In various embodiments, thermal element 4 can include a plurality of distinct thermal elements that contact the plurality of distinct zones in the shell 2, and need not be a continuous thermal element across all zones. In some embodiments, the distinct zones includes approximately ten zones in upper half 6 of the steam turbine shell 2 and approximately ten zones in lower half 8 of the steam turbine shell 2.

Decision D2: determining whether a difference (ΔT) between a temperature of a zone (e.g., U₁, U₂, U₃) in upper half 6 of steam turbine shell 2 and a temperature of a neighboring zone (e.g., L₁, L₂, L₃) in lower half 8 of steam turbine shell 2 exceeds a threshold. In some embodiments, the threshold includes a range of temperature values, e.g., where different values are tailored to different zones. In other cases, the threshold temperature can include a single temperature value (e.g., between approximately zero (0) to approximately thirty (30) degrees Celsius). In various embodiments, this includes comparing the measured temperature (from sensors 10) in a plurality of zones to determine whether a difference (ΔT) in the temperature between zones on one side of the mid-line (rotor) 14 and the other side of mid-line 14 exceeds the threshold. This can include, for example comparing temperatures of each upper zone with a contacting zone in the lower half 8, e.g., U₃ is compared with each of L₂, L₃ and L₄, while U₅ is compared with each of L₄, L₅ and L₆. This may be particularly helpful where a fault occurs in one or more zones, and temperatures of neighboring zones, by contrast, indicate that a fault is occurring and can provide compensation for the fault.

Process P3: initiating a change in a state of thermal element 4 in at least one of an adjacent zone (e.g., U1, U2, L1, L2, etc.) to at least one of the zone in the upper half (e.g., U1, U2, etc.) of steam turbine shell 2 or the neighboring zone in the lower half (e.g., L1, L2, etc.) of steam turbine shell 2 in response to determining the difference (ΔT) exceeds the threshold (Yes to Decision D2). As noted herein, a change in a state of thermal element 4 is a change from one of the “on” (providing heat) position to the “off” (no longer providing heat) position, or vice versa. Modifying the state to “on” from “off” will increase the temperature of the thermal element 4, while modifying the state to “off” from “on” will decrease the temperature of the thermal element 4. It is understood that this change in state may trigger a progressive modification of the temperature of thermal element 4, as the element warms or cools. In various embodiments, the adjacent zone includes a zone contacting the at least one of the zone in upper half 6 of steam turbine shell 2 or the neighboring zone in lower half 8 of steam turbine shell 2, an opposing zone in an opposite one of the upper half 6 of steam turbine shell 2 or lower half 8 of steam turbine shell 2, or a zone contacting the opposing zone in the opposite one of upper half 6 of the steam turbine shell 2 or lower half 8 of steam turbine shell 2. More particularly, this process can include initiating a change in state in thermal element 4 (e.g., by actuating the thermal element via hard-wired and/or wireless communication) in at least one zone which contacts the zone in the upper half 6 or the lower half 8 where the difference (ΔT) exceeds the threshold. For example, where a difference (ΔT) between neighboring zones U3 and L4 exceeds the threshold, this process can include initiating a change in state in at least one of zones U2 (contacting U2), U4 (contacting U3 and L4), U5 (contacting L4), L2 (contacting U3), L3 (contacting U3 and L4) and L5 (contacting L4). Following process P3, the method can include returning to Process P1 in order to obtain temperature data about distinct zones in the upper half 6 and lower half 8 of shell 2.

Decision D4 (in response to a No to Decision D2): determine whether the temperature of a zone (e.g., U1, U2, etc.) in the upper half 6 of the steam turbine shell 2 deviates from an absolute threshold. In various embodiments, this process can include comparing the measured temperature of an upper half zone (e.g., U2, U3, etc.) with an absolute lower or upper threshold (e.g., a single temperature value or a range of temperatures).

Process P5 (in response to Yes to Decision D4): initiate a change in state in the thermal element 4 in at least one of an adjacent zone (e.g., U2 or U5) to the zone (e.g., U3) in upper half 6 of steam turbine shell 2 or the zone (e.g., U3) in upper half 6 of steam turbine shell 2 in response to determining the temperature of the zone (e.g., U3) in upper half 6 of steam turbine shell 2 deviates from the absolute threshold. In various embodiments, process P5 is performed after process P3 (if necessary), and in particular, after decision D2, such that addressing a measured difference (ΔT) between upper 6 and lower 8 sections takes priority over addressing the temperature of sections in the upper half 6 relative to the absolute threshold. Following process P5, the method can include returning to Process P1 in order to obtain temperature data about distinct zones in the upper half 6 and lower half 8 of shell 2.

In the case that Decision D4 results in a No, i.e., that the temperature of the zone (e.g., U1, U2, etc.) in upper half 6 does not deviate from the absolute threshold (e.g., does not exceed threshold, fall outside of the range, etc.), the process may end (END). In other cases, the process (e.g., P1-P5) can be repeated, e.g., periodically such as x times per period y or continuously, or on demand, to monitor the temperature (relative and absolute) of zones within shell 2.

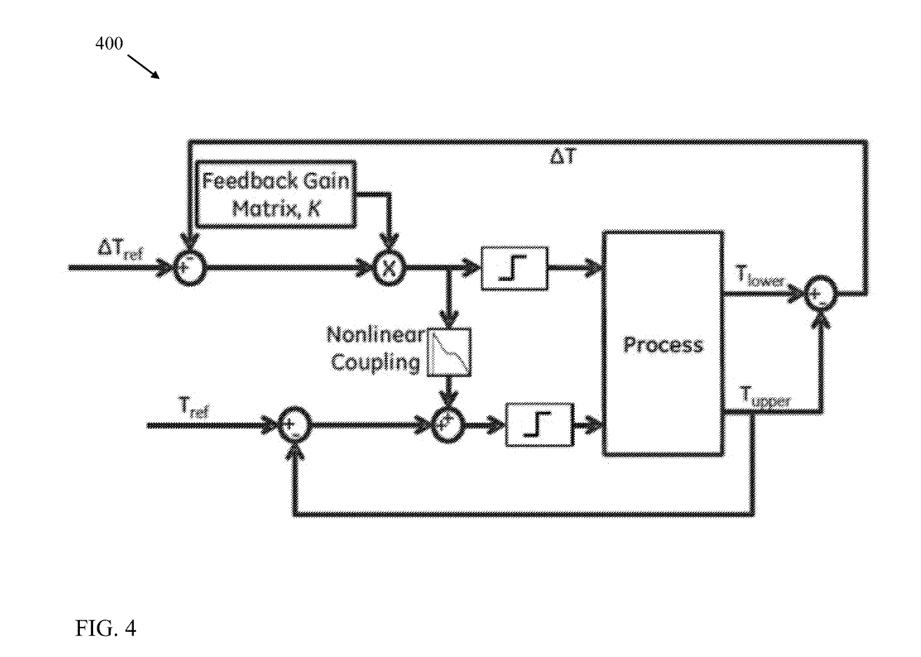

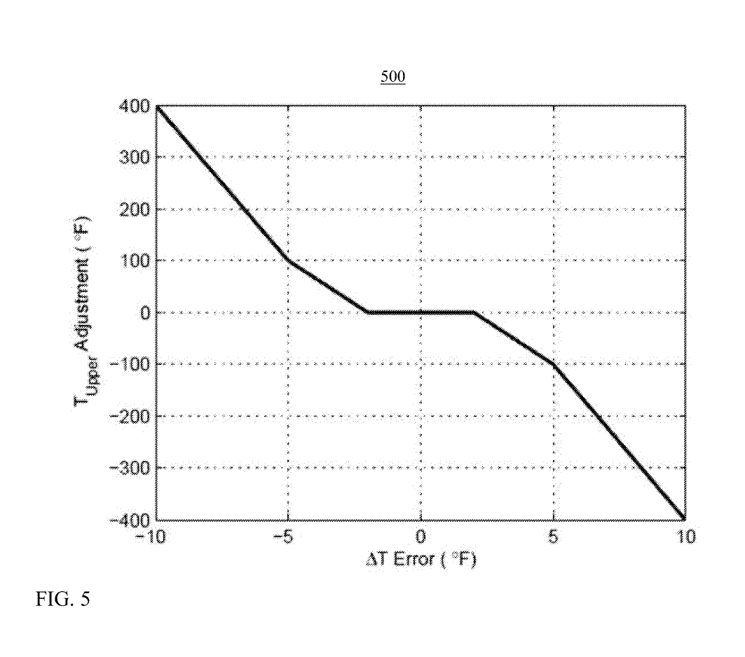

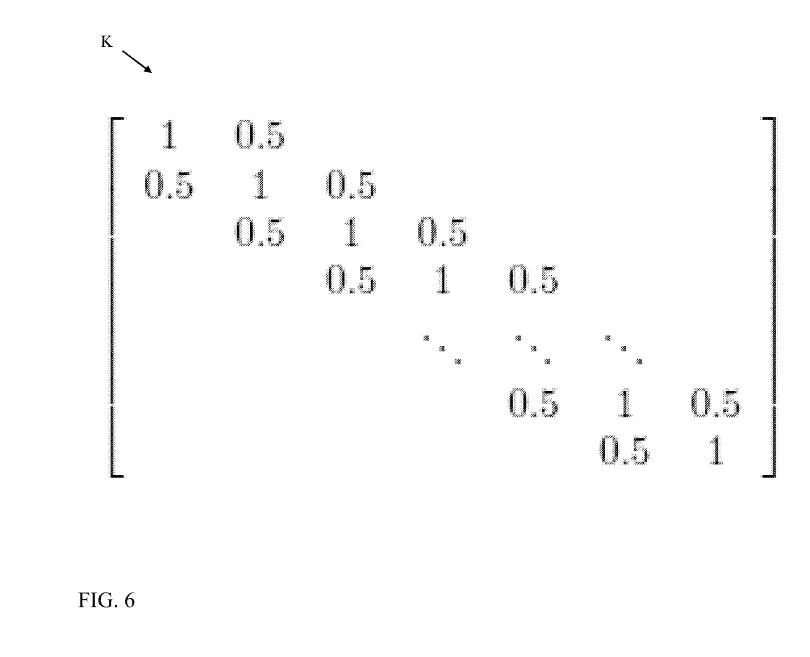

FIG. 4 shows a schematic signal diagram 400 illustrating example control processes according to various embodiments. In this signal diagram 400, the signals T_{lower} and Tᵤₚₚₑᵣ are arrays representing the collection of zones (e.g., U1, U2, L1, L2) in each half of shell 2. Relay symbols at each process input represent the on/off nature of the control loop. These two main feedback loops control the temperature differential (ΔT) between the upper half 6 and lower half 8, and the absolute temperature of upper half 6. In this example, each control loop represents a set of control loops, e.g., if there are a total of ten (10) zones in each shell half (10 upper zones and 10 lower zones), the control process would have a total of twenty (20) loops. With continuing reference to FIG. 4, selection of ΔT and Tᵤₚₚₑᵣ enable the handling of failure modes involving loss and/or degradation of heating capability in upper half 6 of shell 2. That is, as the element(s) 4 on lower half 8 are dedicated to ΔT control, the temperature of lower half 8 will follow the dropping temperature of upper half 6 (with an offset equal to ΔT_{ref}. In this case, the priority is given to differential temperature control, as the impact of failing to control the temperature differential between upper half 6 and lower half 8 is more severe than the failure to control absolute temperature of shell 2. The nonlinear coupling affect on the Tᵤₚₚₑᵣ loop based upon the ΔT tracking error can serve the purpose of accommodating failure modes when either the ability to raise the temperature of lower half 8 has been diminished, or upper half 6 is overheated (e.g., such as when a contactor becomes stuck and results in a continuous heat supply). This nonlinear coupling affect is illustrated in the example graphical depiction of Tᵤₚₚₑᵣ Adjustment (in degrees Fahrenheit(F)) v. ΔT Error (in degrees F.) in FIG. 5. FIG. 6 shows an example feedback gain matrix (K) from the control diagram of FIG. 4. All values not shown in the matrix K are set to zero. This feedback gain matrix K can provide a coupled response to errors in tracking ΔT, e.g., so that neighboring element zones can compensate for errors in one or more zones. This example matrix K can weight the error associated with the diagonal elements (i.e., the impact of the error tracking in a zone on the heater state of that zone) with a unitary gain, while weighing the adjacent zone with a smaller weight.

Example Control Scenario

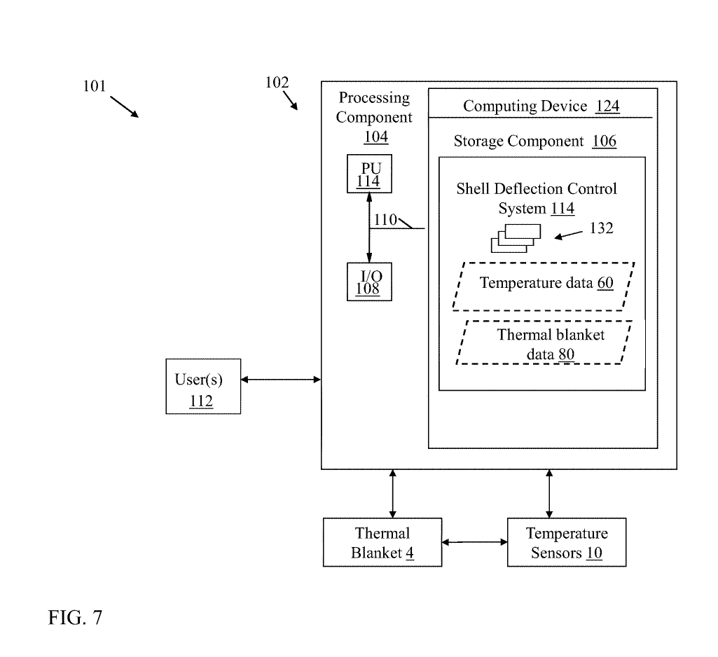

According to various embodiments, the shell deflection control system 114 (FIG. 7) can initiate the following control functions to control deflection in ST shell 2 (e.g., using connection with thermal element 4 and temperature sensors 10):

Process P101: determining a temperature of each of a plurality of zones (e.g., U1, U2, L1, L2) using temperature sensors 10.

Process P102: calculating a temperature differential for each corresponding upper/lower zone pairing (e.g., U1 and L1; U2 and L2).

Process P103: calculating a difference (if existent) between a desired (target) temperature differential (deltaT) between each corresponding upper/lower zone pairing and the measured/calculated temperature differential between those corresponding upper/lower zone pairings.

Process P104: For each upper/lower zone pairing, calculating a weighted sum of the deltaT error in that upper/lower zone pairing and all of the remaining zones in the upper half 6 and lower half 8 of shell 2 as prescribed by a feedback gain matrix (e.g., matrix K in FIG. 6). For example, for values shown in matrix K in FIG. 6, the weighted sum for zone pairing number 3 (U3, L3) would be equal to: Sum_ZP3=1.0*Error_deltaT3+0.5*Error_deltaT2+0.5*Error_deltaT4. In various embodiments, additional zones can be incorporated, depending upon the configuration of the gain matrix (e.g., matrix K)

Process P105: For each upper/lower zone pairing, if the value of the weighted sum (calculated in process P104) is greater than zero (i.e., deltaT is lower than desired) maintaining (in an “on” state) or initiating a change from “off” state to “on” state in the corresponding lower half zone (L1, L2, etc.) in heating element 4 in order to increase the differential and meet the deltaT goal. If the weighted sum is less than zero (i.e., deltaT is higher than desired), initiating a change from the “on” state to the “off” state in the corresponding lower half zone in heating element 4 in order to reduce the differential and meet the deltaT goal.

Process P106: For each upper half zone (e.g. U1, U2, etc.), calculate a difference (if any) between the desired (reference) temperature and the measured temperature (as determined by sensors 10), dubbed the “temperature error.”

Process P107: For reach upper half zone (e.g., U1, U2, etc.), add the temperature error (from process P106) and a nonlinear function (“nonlinear coupling” function) of the weighted sum from process P4 (i.e., calculate a new sum for upper half 6 to get: Sum_UZ3=Error_T3+f_NC(Sum_ZP3), where f_NC is the nonlinear coupling function and acts on the weighted sum from process P104.

Process P108: For each upper half zone (e.g., U1, U2, etc.), if the new sum (Sum_UZ#) from process P107 is greater than zero, maintaining (in an “on” state) or initiating a change from “off” state to “on” state in the corresponding upper half zone (U1, U2, etc.). If the new sum (Sum_UZ#) is less than zero, initiating a change from the “on” state to the “off” state in the corresponding upper half zone (e.g., U1, U2, U3) in heating element 4.

It is understood that in the flow diagrams shown and described herein, other processes may be performed while not being shown, and the order of processes can be rearranged according to various embodiments. Additionally, intermediate processes may be performed between one or more described processes. The flow of processes shown and described herein is not to be construed as limiting of the various embodiments.

FIG. 7 shows an illustrative environment 101 including an ST shell deflection control system 114, for performing the functions described herein according to various embodiments of the invention. To this extent, the environment 101 includes a computer system 102 that can perform one or more processes described herein in order to monitor and/or control deflection in a ST shell 2 (FIG. 1). In particular, the computer system 102 is shown as including the shell deflection control system 114, which makes computer system 102 operable to control deflection in a ST shell 2 (e.g., using connection with thermal element 4 and temperature sensors 10) performing any/all of the processes described herein and implementing any/all of the embodiments described herein.

The computer system 102 is shown including a computing device 124, which can include a processing component 104 (e.g., one or more processors), a storage component 106 (e.g., a storage hierarchy), an input/output (I/O) component 108 (e.g., one or more I/O interfaces and/or devices), and a communications pathway 110. In general, the processing component 104 executes program code, such as the shell deflection control system 114, which is at least partially fixed in the storage component 106. While executing program code, the processing component 104 can process data, which can result in reading and/or writing transformed data from/to the storage component 106 and/or the I/O component 108 for further processing. The pathway 110 provides a communications link between each of the components in the computer system 102. The I/O component 108 can comprise one or more human I/O devices, which enable a user (e.g., a human and/or computerized user) 112 to interact with the computer system 102 and/or one or more communications devices to enable the system user 112 to communicate with the computer system 102 using any type of communications link. To this extent, the shell deflection control system 114 can manage a set of interfaces (e.g., graphical user interface(s), application program interface, etc.) that enable human and/or system users 112 to interact with the shell deflection control system 114. Further, the shell deflection control system 114 can manage (e.g., store, retrieve, create, manipulate, organize, present, etc.) data, such as temperature data 60 (e.g., data about the temperature of one or more zones (e.g., U1, U2, L1, L2, etc., in shell 2, as indicated by temperature sensor(s) in the zones) and/or thermal element data 80 (e.g., data about the power status (e.g., on/off/high/low) of thermal element 4) using any solution, e.g., via wireless and/or hardwired means.

In any event, the computer system 102 can comprise one or more general purpose computing articles of manufacture (e.g., computing devices) capable of executing program code, such as the shell deflection control system 114, installed thereon. As used herein, it is understood that “program code” means any collection of instructions, in any language, code or notation, that cause a computing device having an information processing capability to perform a particular function either directly or after any combination of the following: (a) conversion to another language, code or notation; (b) reproduction in a different material form; and/or (c) decompression. To this extent, the shell deflection control system 114 can be embodied as any combination of system software and/or application software. It is further understood that the shell deflection control system 114 can be implemented in a cloud-based computing environment, where one or more processes are performed at distinct computing devices (e.g., a plurality of computing devices 124), where one or more of those distinct computing devices may contain only some of the components shown and described with respect to the computing device 124 of FIG. 4.

Further, the shell deflection control system 114 can be implemented using a set of modules 132. In this case, a module 132 can enable the computer system 102 to perform a set of tasks used by the shell deflection control system 114, and can be separately developed and/or implemented apart from other portions of the shell deflection control system 114. As used herein, the term “component” means any configuration of hardware, with or without software, which implements the functionality described in conjunction therewith using any solution, while the term “module” means program code that enables the computer system 102 to implement the functionality described in conjunction therewith using any solution. When fixed in a storage component 106 of a computer system 102 that includes a processing component 104, a module is a substantial portion of a component that implements the functionality. Regardless, it is understood that two or more components, modules, and/or systems may share some/all of their respective hardware and/or software. Further, it is understood that some of the functionality discussed herein may not be implemented or additional functionality may be included as part of the computer system 102.

When the computer system 102 comprises multiple computing devices, each computing device may have only a portion of shell deflection control system 114 fixed thereon (e.g., one or more modules 132). However, it is understood that the computer system 102 and shell deflection control system 114 are only representative of various possible equivalent computer systems that may perform a process described herein. To this extent, in other embodiments, the functionality provided by the computer system 102 and shell deflection control system 114 can be at least partially implemented by one or more computing devices that include any combination of general and/or specific purpose hardware with or without program code. In each embodiment, the hardware and program code, if included, can be created using standard engineering and programming techniques, respectively.

Regardless, when the computer system 102 includes multiple computing devices 124, the computing devices can communicate over any type of communications link. Further, while performing a process described herein, the computer system 102 can communicate with one or more other computer systems using any type of communications link. In either case, the communications link can comprise any combination of various types of wired and/or wireless links; comprise any combination of one or more types of networks; and/or utilize any combination of various types of transmission techniques and protocols.

While shown and described herein as a method and system for controlling deflection in a ST shell 2 (FIG. 1), it is understood that aspects of the invention further provide various alternative embodiments. For example, in one embodiment, the invention provides a computer program fixed in at least one computer-readable medium, which when executed, enables a computer system to controlling deflection in a ST shell 2. To this extent, the computer-readable medium includes program code, such as the shell deflection control system 114 (FIG. 7), which implements some or all of the processes and/or embodiments described herein. It is understood that the term “computer-readable medium” comprises one or more of any type of tangible medium of expression, now known or later developed, from which a copy of the program code can be perceived, reproduced, or otherwise communicated by a computing device. For example, the computer-readable medium can comprise: one or more portable storage articles of manufacture; one or more memory/storage components of a computing device; paper; etc.

In another embodiment, the invention provides a method of providing a copy of program code, such as the shell deflection control system 114 (FIG. 7), which implements some or all of a process described herein. In this case, a computer system can process a copy of program code that implements some or all of a process described herein to generate and transmit, for reception at a second, distinct location, a set of data signals that has one or more of its characteristics set and/or changed in such a manner as to encode a copy of the program code in the set of data signals. Similarly, an embodiment of the invention provides a method of acquiring a copy of program code that implements some or all of a process described herein, which includes a computer system receiving the set of data signals described herein, and translating the set of data signals into a copy of the computer program fixed in at least one computer-readable medium. In either case, the set of data signals can be transmitted/received using any type of communications link.

In still another embodiment, the invention provides a method of controlling deflection in a ST shell 2 (FIG. 1). In this case, a computer system, such as the computer system 102 (FIG. 7), can be obtained (e.g., created, maintained, made available, etc.) and one or more components for performing a process described herein can be obtained (e.g., created, purchased, used, modified, etc.) and deployed to the computer system. To this extent, the deployment can comprise one or more of: (1) installing program code on a computing device; (2) adding one or more computing and/or I/O devices to the computer system; (3) incorporating and/or modifying the computer system to enable it to perform a process described herein; etc.

In any case, the technical effect of the various embodiments of the invention, including, e.g., the shell deflection control system 114, is to control deflection of a ST shell 2. It is understood that according to various embodiments, the shell deflection control system 114 could be implemented to monitor deflection in a plurality of distinct ST shells similar to ST shell 2.

In various embodiments, components described as being “coupled” to one another can be joined along one or more interfaces. In some embodiments, these interfaces can include junctions between distinct components, and in other cases, these interfaces can include a solidly and/or integrally formed interconnection. That is, in some cases, components that are “coupled” to one another can be simultaneously formed to define a single continuous member. However, in other embodiments, these coupled components can be formed as separate members and be subsequently joined through known processes (e.g., fastening, ultrasonic welding, bonding).

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

We claim:

1. A system comprising:
at least one computing device configured to control a state of a thermal element in contact with a steam turbine shell having an upper half and a lower half, by performing actions including:
obtaining temperature data indicating temperatures of distinct zones in the upper half of the steam turbine shell and the lower half of the steam turbine shell, the thermal element having corresponding distinct zones as the upper half of the steam turbine shell and the lower half of the steam turbine shell;
determining whether a difference between a temperature of a zone in the upper half of the steam turbine shell and a temperature of a neighboring zone in the lower half of the steam turbine shell exceeds a threshold; and
initiating a change in the state of the thermal element in at least one of an adjacent zone to at least one of the zone in the upper half of the steam turbine shell or the neighboring zone in the lower half of the steam turbine shell in response to determining the difference exceeds the threshold.

2. The system of claim 1, wherein the distinct zones includes approximately ten zones in the upper half of the steam turbine shell and approximately ten zones in the lower half of the steam turbine shell.

3. The system of claim 1, wherein the at least one computing device is further configured to:
determine whether the temperature of a zone in the upper half of the steam turbine shell deviates from an absolute threshold; and
initiate a change in the state of the thermal element in at least one of an adjacent zone to the zone in the upper half of the steam turbine shell or the zone in the upper half of the steam turbine shell in response to determining the temperature of the zone in the upper half of the steam turbine shell deviates from the absolute threshold.

4. The system of claim 3, wherein the absolute threshold includes a temperature range.

5. The system of claim 3, wherein the initiating of the change in the state of the thermal element in response to determining the temperature of the zone in the upper half of the steam turbine shell deviates from the absolute threshold is performed after the initiating of the change in temperature in the thermal element in response to determining the difference exceeds the threshold.

6. The system of claim 1, wherein the threshold includes a temperature range.

7. The system of claim 1, wherein the adjacent zone includes a zone contacting the at least one of the zone in the upper half of the steam turbine shell or the neighboring zone in the lower half of the steam turbine shell, an opposing zone in an opposite one of the upper half of the steam turbine shell or the lower half of the steam turbine shell, or a zone contacting the opposing zone in the opposite one of the upper half of the steam turbine shell or the lower half of the steam turbine shell.

8. A computer program product comprising program code, which when executed by one computing device, causes the at least one computing device to control a state of the thermal element in contact with a steam turbine shell having an upper half and a lower half, by performing actions including:
obtaining temperature data indicating temperatures of distinct zones in the upper half of the steam turbine shell and the lower half of the steam turbine shell, the thermal element having corresponding distinct zones as the upper half of the steam turbine shell and the lower half of the steam turbine shell;
determining whether a difference between a temperature of a zone in the upper half of the steam turbine shell and a temperature of a neighboring zone in the lower half of the steam turbine shell exceeds a threshold; and
initiating a change in the state of the thermal element in at least one of an adjacent zone to at least one of the zone in the upper half of the steam turbine shell or the neighboring zone in the lower half of the steam turbine shell in response to determining the difference exceeds the threshold.

9. The computer program product of claim 8, wherein the distinct zones includes approximately ten zones in the upper half of the steam turbine shell and approximately ten zones in the lower half of the steam turbine shell.

10. The computer program product of claim 8, wherein the program code causes the at least one computing device to:
determine whether the temperature of a zone in the upper half of the steam turbine shell deviates from an absolute threshold; and
initiate a change in the state of the thermal element in at least one of an adjacent zone to the zone in the upper half of the steam turbine shell or the zone in the upper half of the steam turbine shell in response to determining the temperature of the zone in the upper half of the steam turbine shell deviates from the absolute threshold.

11. The computer program product of claim 10, wherein the absolute threshold includes a temperature range.

12. The computer program product of claim 10, wherein the initiating of the change in the state of the thermal element in response to determining the temperature of the zone in the upper half of the steam turbine shell deviates from the absolute threshold is performed after the initiating of the change in the state of the thermal element in response to determining the difference exceeds the threshold.

13. The computer program product of claim 8, wherein the threshold includes a temperature range.

14. The computer program product of claim 8, wherein the adjacent zone includes a zone contacting the at least one of the zone in the upper half of the steam turbine shell or the neighboring zone in the lower half of the steam turbine shell, an opposing zone in an opposite one of the upper half of the steam turbine shell or the lower half of the steam turbine shell, or a zone contacting the opposing zone in the opposite one of the upper half of the steam turbine shell or the lower half of the steam turbine shell.

15. A system comprising:
a thermal element for contacting a steam turbine shell having an upper half and a lower half; and
a control system including at least one computing device configured to control a state of the thermal element by performing actions including:
obtaining temperature data indicating temperatures of distinct zones in the upper half of the steam turbine shell and the lower half of the steam turbine shell, the thermal element having corresponding distinct zones as the upper half of the steam turbine shell and the lower half of the steam turbine shell;
determining whether a difference between a temperature of a zone in the upper half of the steam turbine shell and a temperature of a neighboring zone in the lower half of the steam turbine shell exceeds a threshold; and
initiating a change in the state of the thermal element in at least one of an adjacent zone to at least one of the zone in the upper half of the steam turbine shell or the neighboring zone in the lower half of the steam turbine shell in response to determining the difference exceeds the threshold.

16. The system of claim 15, wherein the distinct zones includes approximately ten zones in the upper half of the steam turbine shell and approximately ten zones in the lower half of the steam turbine shell.

17. The system of claim 15, wherein the at least one computing device is further configured to:
determine whether the temperature of a zone in the upper half of the steam turbine shell deviates from an absolute threshold; and
initiate a change in the state of the thermal element in at least one of an adjacent zone to the zone in the upper half of the steam turbine shell or the zone in the upper half of the steam turbine shell in response to determining the temperature of the zone in the upper half of the steam turbine shell deviates from the absolute threshold.

18. The system of claim 17, wherein the initiating of the change in the state of the thermal element in response to determining the temperature of the zone in the upper half of the steam turbine shell deviates from the absolute threshold is performed after the initiating of the change in temperature in the thermal element in response to determining the difference exceeds the threshold.

19. The system of claim 15, wherein the threshold includes a temperature range.

20. The system of claim 15, wherein the adjacent zone includes a zone contacting the at least one of the zone in the upper half of the steam turbine shell or the neighboring zone in the lower half of the steam turbine shell, an opposing zone in an opposite one of the upper half of the steam turbine shell or the lower half of the steam turbine shell, or a zone contacting the opposing zone in the opposite one of the upper half of the steam turbine shell or the lower half of the steam turbine shell.
